(19) United States
(12) Patent Application Publication
(10) Pub. No.: US 2003/0156819 A1
(43) Pub. Date: Aug. 21, 2003

(54) Optical waveguide

(76) Inventors: Mark Pruss, Story City, IA (US); Patrick Jeffery Condon, Ames, IA (US)

Correspondence Address: GREENBERG TRAURIG, P.C., 77 WEST WACKER DRIVE, CHICAGO, IL, 60601-1732, US

(21) Appl. No.: 10/077,462

(22) Filed: Feb. 15, 2002

(51) Int. Cl. G02B 6/10; G02B 6/26; F21V 8/00

(52) U.S. Cl. 385/146; 385/901; 385/43; 362/551

(57) ABSTRACT

An optical waveguide for use in converting the distribution pattern of light from a limited output light source, such as an LED, to a substantially unlimited, rotationally symmetric distribution pattern. The optical waveguide includes a guide, a collection optic and a distribution optic. The collection optic includes both refractive and reflective portions, while the distribution optic includes a first reflective optical surface and a second refractive optical surface. The first and second optical surfaces act in combination to minimize the virtual focal region of the waveguide. The waveguide is suitable for use in a number of applications involving an outer lens or secondary optic. For instance, the waveguide may be used in the lighting unit of warning barricade device, wherein the light distributed by the waveguide is transmitted to the outside environment through a fresnel lens.

### BACKGROUND OF THE INVENTION

1. Field of the Invention

The present invention relates in general to an optical waveguide for transforming the limited spatial distribution pattern of a light source into a substantially radially symmetric spatial distribution and, more particularly, to an optical waveguide for use in the lighting unit of a warning barricade apparatus.

2. Background Art

Barricade structures for marking the presence of a construction site or other potentially hazardous location along a road or sidewalk have been in existence for many years. These warning barricades typically employ a battery-powered, self-contained warning light on the top of the barricade to warn motorists, pedestrians and others who encounter hazardous sites, particularly during periods of limited light such as at nighttime and/or during inclement weather. Typically, the warning light includes a base to house a power source such as batteries, as well as an outer lens, such as a conventional amber fresnel lens. The outer lens is typically pivotal relative to the base to permit optimal orientation of the lens for viewability by drivers and other pedestrians.

Many barricade lighting units have employed conventional incandescent light sources inside of the protective outer lens. These incandescent sources generally include a filament which emits light substantially uniformly in all directions through a bulb. Given the substantially uniform light distribution, use of an incandescent source permits rotation of the outer lens to any desired orientation. However, incandescent lights use a substantial amount of power, thus requiring the batteries in the lighting units to be changed quite frequently, adding time and expense to the task of maintaining the warning barricade in use.

To help solve this problem, many current warning barricades now employ lighting units having one or more light emitting diode (LED) light sources. LEDs have a greater energy conversion efficiency than incandescent bulbs, and thus allow the batteries in the warning light to have a much longer life span during use of warning barricades.

While LEDs have reduced the amount of time, labor and expense in maintaining the lighting units of warning barricades, warning lighting units employing LEDs have experienced other difficulties. In particular, LEDs exhibit a limited spatial distribution output pattern, unlike an incandescent light source, which emits rather uniformly into a substantially radial symmetric hemispherical pattern. Accordingly, LEDs produce a localized energy concentration, a “bright spot”, on the lens. The location of the localized energy concentration is typically on the optical axis of the LED, which in most cases is also the mechanical axis of the LED. Typically, warning lights that have been modified to use an LED as the light source have fixed the LED in a particular direction. A problem then occurs when the lens, which has its own optical axis, is rotatable perpendicularly around the optical axis of the LED. When these two axes are not in alignment, the output of the warning light produces very little, if any, visible light for oncoming motorists or pedestrians. In addition, the warning light may not pass required governmental regulations.

Attempts have been made to address this problem. For instance, Lindner, U.S. Pat. No. 5,490,045, discloses a barrier light with an outer lens which is pivotal relative to the lighting unit base and the warning barricade. The barrier light employs two limited output LEDs which are directed to the front and rear faces of the outer lens, respectively, thus aligning the optical axis of the LEDs with the optical axis of the warning light lens. To address the problem of rotating the outer lens, the LEDs are part of a sub-assembly which rotates in unison with the outer lens, thus maintaining the alignment of the optical axis of the LED and lens.

While this and other solutions have worked well, there is a tendency for the wires extending from the LEDs in a Lindner-type lighting unit to become twisted and thus lead to complications with the LED rotational sub-assembly. Moreover, the spatial distribution pattern of light from the LEDs, whether those LEDs rotate with the outer lens or not, is still very limited, and thus leads to a localized light concentration area in the outer lens, rather than a more uniform light distribution pattern from the outer lens. Thus, it remains a goal in the art to provide a warning barricade which capitalizes on the efficiency of an LED light source, but which provides a more uniform, rotationally symmetric distribution pattern similar to that of an incandescent light.

It is further a goal to provide an output distribution pattern from a light source contained within a lighting unit which allows rotation of the outer lens of the warning light to any orientation, while maintaining the light source in a fixed relationship relative to the base of the lighting unit—thus eliminating any substantial moving parts in the lighting assembly and any susceptibility to problems arising therefrom.

It is yet a further goal to provide a primary light source having a small virtual focal point and/or region to facilitate control and maximization of light emitted from an outer lens or secondary optic.

It is yet another goal to provide an optical waveguide which converts the distribution pattern of light emitted from a limited spatial distribution light source, such as an LED, to a substantially uniform, rotationally symmetric distribution pattern.

### SUMMARY OF THE INVENTION

The present invention is directed to an optical waveguide for use in converting the distribution pattern of light from a limited spatial distribution light source, such as an LED, to a substantially unlimited, rotationally symmetric distribution pattern. The optical waveguide includes a guide, a collection optic and a distribution optic. In a preferred embodiment, the waveguide is constructed from light transmitting materials, such as acrylic, glass, polycarbonate or polystyrene.

The collection optic preferably includes both refractive and reflective portions, to capture both narrow angle and wide-angle light emitted from the light source. In a preferred embodiment, the collection optic collimates the substantial majority of the collected light into the guide.

The guide is preferably circular, and axially symmetric about a longitudinal axis running through the middle of the waveguide. In a preferred embodiment, the guide is tapered from a larger diameter at its bottom end proximate the collection optic, to a smaller diameter at its top end proximate the distribution optic. The tapered configuration of the guide focuses the light collected through the collection optic, and preferably reduces the virtual focal region of the waveguide. Additionally, the inside surface of the guide preferably acts as a total internal reflector to the incident light rays traveling from the collection optic to the distribution optic.

The distribution optic includes a first optical surface and a second optical surface. In a preferred embodiment, the first optical surface is reflective. In one preferred embodiment, at least a portion of the first optical surface is covered with a reflective coating such as aluminum, silver, silicon dioxide, iron dioxide chromium, or other reflective metallic materials or compounds, or a dielectric mirror coating, or a combination thereof. In another preferred embodiment, the first optical surface is totally internally reflective, without a coating. The first optical surface is preferably concave.

The second optical surface is preferably convex, and refracts light reflected off of the first optical surface into the surrounding environment. The light distribution pattern emitted from the distribution optic is preferably rotationally and axially symmetric, thus giving off equal intensity in each rotational direction—much like an incandescent light. Moreover, the first and second optical surfaces preferably act in combination to minimize the virtual focal region of the waveguide, to enhance control and efficiency of the light distribution pattern.

The waveguide is suitable for use in a number of applications involving an outer lens or secondary optic. For instance, the waveguide may be used in the lighting unit of warning barricade device, wherein the light distributed by the waveguide is transmitted to the outside environment through a secondary optic. In one preferred embodiment, the secondary optic comprises a fresnel lens.

Also in this embodiment, the waveguide is preferably secured in the lighting unit, to allow rotation of the outer lens around the waveguide to optimize its orientation relative to oncoming traffic or pedestrians. To this end, the waveguide may further include a connection structure to facilitate attachment of the waveguide to the lighting unit. In one preferred embodiment, the connection structure may be formed integrally with the waveguide. In another preferred embodiment, the connection structure may be a separate piece attachable to the waveguide.

Also in a preferred embodiment, the connection structure may include gripping members to secure the light source and/or a current regulator, such as a circuit board, relative to the collection optic of the waveguide. Further, the connection structure may include retaining extensions which prevent rotation of the waveguide relative to the lighting unit, but which permit removable attachment of the waveguide relative to the lighting unit.

### BRIEF DESCRIPTION OF THE DRAWINGS

FIG. 1 is a front elevational view of a warning barricade device according to the present invention;

FIG. 2 is a front elevational exploded view of a lighting unit for use with the warning barricade shown in FIG. 1;

FIG. 3 is a side elevational view in cross-section of the lighting unit taken along the lines 3-3 of FIG. 1;

FIG. 4 is a front elevational view in cross-section of the lighting unit taken along the lines 4-4 of FIG. 3; FIG. 5 is a perspective view of the optical waveguide shown in FIGS. 2-4;

FIG. 6 is a front elevational view in cross-section of the optical waveguide taken along the lines 6-6 of FIG. 5;

FIG. 7 is a front elevational view in cross-section of the top portion of the optical waveguide shown in FIG. 5;

FIG. 8 is a front elevational view in cross-section of the bottom portion of the optical waveguide shown in FIG. 5;

FIG. 9 is a side elevational view in cross-section of the bottom portion of the optical waveguide shown in FIG. 5;

FIG. 10 is a front elevational view in cross-section of the top portion of the optical waveguide shown in FIG. 5, illustrating emission of light rays from the waveguide by the distribution optic;

FIG. 11 is a front elevational view in cross-section of the bottom portion of the optical waveguide shown in FIG. 5, illustrating collection of light from the light source by the collection optic; and

FIG. 12 is a front elevational view in cross-section of the top portion of an optical waveguide according to another embodiment of the present invention.

### DETAILED DESCRIPTION OF THE INVENTION

While this invention is susceptible of embodiment in many different forms, there are shown in the drawings and will be described in detail, several specific embodiments with the understanding that the present disclosure is to be considered as an exemplification of the principals of the invention and is not intended to limit the invention to the embodiments illustrated.

Warning barricade 20 is shown is FIG. 1 as comprising barricade member 22 and lighting unit 24. At the outset, while a specific warning barricade is shown, lighting unit 24 may be used in combination with virtually any warning barricade or barrier. Moreover, lighting unit need not be positioned on the top of barricade member 22, but rather may be associated with warning barricade 20 in any manner as would be known by those of ordinary skill in the art with the present disclosure before them. Further, the present invention is certainly not limited to warning barricades, nor to the specific type of warning barrier lighting unit shown in the drawings. Throughout this detailed description, like reference numerals will be used to designate like parts.

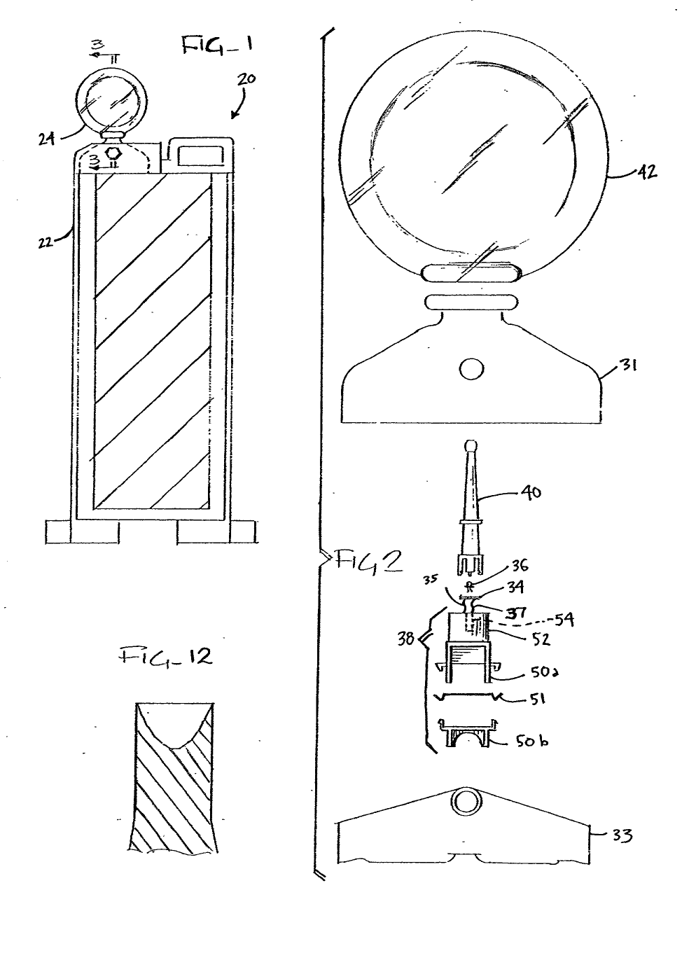

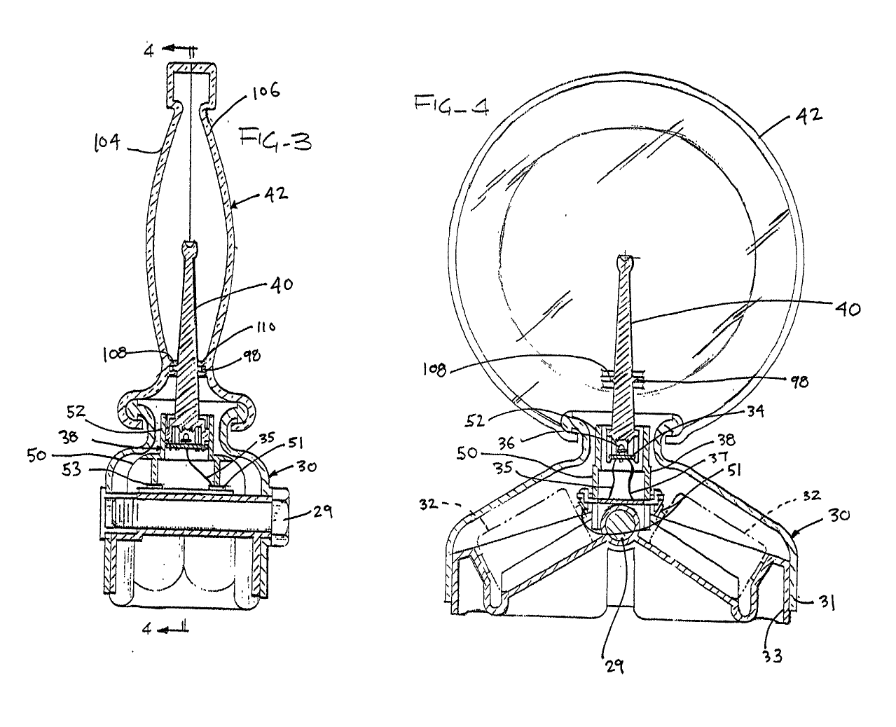

Lighting unit 24 is shown in FIGS. 2-4 as comprising base 30, power supply 32, current regulator 34, light source 36, light source housing 38, primary optic or optical waveguide 40 and secondary optic 42. As is shown in FIGS. 2-4, base 30 preferably comprises a two piece structure, with top piece 31 fitting over bottom piece 33. The two pieces are preferably locked together by bolt 29, shown in FIGS. 3 and 4. Bottom piece 33 houses power supply 32, shown in the drawings as comprising batteries. However, base 30 is just one example of a base which can be used with a warning light. Those with ordinary skill in the art with the present disclosure before them will readily appreciate that base 30 may comprise any conventional base for use with a warning barricade, may include any number of pieces, and may employ various forms of power supply.

Current regulator 34 is shown in FIGS. 2-4, 8 and 9 as comprising a circuit board. Current regulator 34 transforms the power from power source 32, often varied depending on load, into a constant current source to drive light source 36. As is shown in FIGS. 3, 4, 8 and 9, circuit board is preferably positioned inside light source housing 38, with leads 35 and 37 extending to battery contacts 51 and 53, described below. Further, current regulator 34 preferably also includes holes 39 and 41, to facilitate positioning and retention of current regulator 34 relative to waveguide 40. As will be described below, holes 39 and 41 accept pins 88 and 90 located on the bottom of the waveguide.

Light source 36 is shown in FIGS. 2-4, 8 and 9 as comprising an LED. The LED, by nature, emits a limited field light distribution pattern. Typically, an LED source emits a light field of approximately 15°-50° relative to normal, or 30°-100° total including angle degrees. The LED is preferably soldered directly to current regulator 34, to position light source 36 directly below waveguide 40.

Light source housing 38, shown in FIGS. 2-4 and 9, includes base position 50 and candle portion 52. Base portion 50 is shown in FIG. 2 as constructed of two pieces, such as 50a and 50b, and fits into base 30 of lighting unit 24. However, base portion 50 may certainly take other configurations or constructions, as would be known by those of ordinary skill in the art with the present disclosure before them. Base portion 50 further includes contacts 51 and 53, which interface with power supply 32, namely the batteries shown in the drawings. As touched upon above, contacts 51 and 53 are connected to current regulator 34 by leads 35 and 37, which may comprise wires or other such connecting members.

Candle portion 52 is shown in FIGS. 2-4 and 9 as extending upwards from base portion 50. Candle portion 52 is preferably cylindrical and hollow, and includes grooves 54 and 56 positioned on the inside surface thereof. Each groove preferably extends from the top of candle portion 52 to a point a portion of the way down the candle portion. As will be discussed in further detail below, grooves 54 and 56 serve to accept and retain waveguide 40 in candle portion 52, thus maintaining a secure relationship between waveguide 40 and base 30. Grooves are particularly beneficial as they limit rotational movement of waveguide 40. Of course, it is likewise contemplated that instead of grooves, candle portion 52 may include a flange, shoulder or ridge which extends part of the way or all of the way around the inside surface of candle portion 52 to serve as a stop for waveguide 40. Alternatively, waveguide 40 may extend entirely through candle portion 52 and into base portion 50, where it may be anchored. Those with ordinary skill in the art with the present disclosure before them will appreciate that waveguide 40 may be secured inside base 30 of lighting unit 24 in any number of other ways as well.

Primary optic or optical waveguide 40 is shown in FIGS. 2-9 as including first end 58, second end 62 and body 60. First end 58 includes collection optic 64 and connection structure 66. Collection optic 64 collects light from light source 36 and channels that light into waveguide 40. Collection optic 64 is preferably positioned immediately above light source 36, so as to capture the substantial majority of the light emitted by light source 36. Moreover, the collection optic is preferably circular in shape, resulting in an axially symmetric design, which promotes efficient coupling of the light emitted by light source 36 into the waveguide.

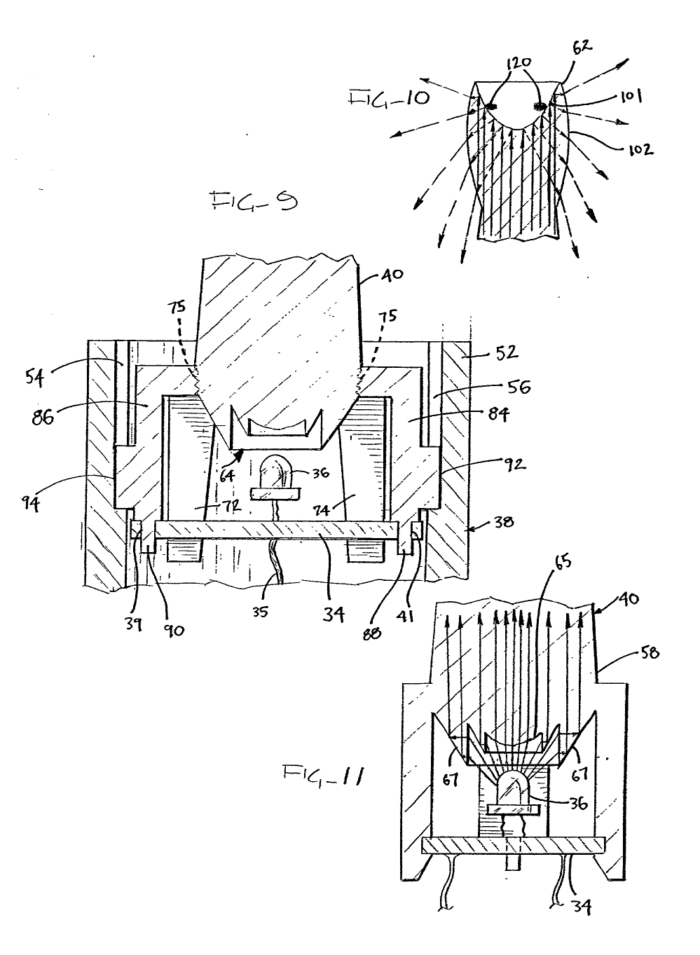

Collection optic 64 is shown in detail in FIGS. 8 and 9 as having a multi-segmented construction, including both refractive portion 65 and reflective portion 67. As is illustrated in FIGS. 10 and 11, refractive portion 65 comprises the central element in collection optic 64, and bends the lower-angle light from light source 36 upward into waveguide 40 toward second end 62 of the waveguide. Reflective portion 67, on the other hand, comprises a series of total internally reflecting surfaces which bend the higher-angle LED light upward toward the second end of the waveguide. Specifically, reflective portion 67 includes inner vertical segments 69 which initially capture the wider angle LED light, which captured light is then reflected off angled segments 71 toward second end 62. The exact dimensions, nature and number of refractive and reflective segments comprising the collection optic may vary, and is preferably tailored to a particular LED output distribution pattern. However, it is likewise contemplated that any number of collection optics which serve to couple light from a limited output light source, such as an LED, toward second end 62 of waveguide 40 are likewise contemplated, as would be known by those with ordinary skill in the art with the present disclosure before them.

Connection structure 66 is shown in FIGS. 3-6, 8 and 9 as comprising gripping prongs 68, 70, 72 and 74, and securing posts 84 and 86. The gripping prongs are preferably flexible and resilient, such that they may be deformed and returned to their initial orientation. Each gripping prong further includes a groove 76 which is of a size to match the thickness of current regulator 34. The flexible gripping prongs clamp to the opposing outside edges of current regulator 34, which fits into grooves 76, such that the gripping prongs maintain current regulator 34 and light source 36 in a fixed position relative to waveguide 40. However, it is likewise contemplated that alternative connection structures may include only one gripping prong for each opposing side of the circuit board, additional gripping prongs to increase stability of the circuit board, or, alternatively, no gripping prongs at all. Certainly, those with ordinary skill in the art with the present disclosure before them will recognize that light source 36 may be secured relative to first end 58 of waveguide 40 in any number of different ways—both involving a circuit board as well as not involving a circuit board.

Securing posts 84 and 86 also further stabilize current regulator 34 and light source 36 relative to waveguide 40. In particular, securing posts 84 and 86 include pins 88 and 90, respectively, as well as extensions 92 and 94, also respectively. Pins 88 and 90 preferably fit into holes 41 and 39 bored into current regulator 34, to further anchor the current regulator and the light source relative to first end 58 of waveguide 40.

Extensions 92 and 94 are positioned on the outer surface of securing posts 84 and 86, respectively, and preferably slide into opposing grooves 54 and 56 in candle portion 52 of light source housing 38. This fit maintains waveguide 40 in a stable, fixed, secure relationship relative to light source housing 38, base 30 and lighting unit 24. However, it is likewise contemplated that waveguide 40 may be secured in light source housing 38 in any number of different ways as would be known by those with ordinary skill in the art with the present disclosure before them, such as by flanges or ridges positioned on the inner wall of the candle portion. Indeed, waveguide 40 may also be secured in base portion 50 of light source housing 38.

Additionally, while connection structure 66 is shown as formed directly with and integrated into waveguide 40, it is likewise contemplated that connection structure 66 may be separately formed and attached to waveguide 40. For instance, connection structure 66 may be screwed on (see mating threads 75 on both waveguide 40 and connection structure 66 in FIG. 5), snapped on or attached in any number of available ways. To this end, any number of connection structures are contemplated for use with the present invention which would allow waveguide 40 to be secured in and/or relative to light source housing 38 and base 30 of lighting unit 24. Indeed, inasmuch as the limited light field emitted from light source 36 is preferably transformed by waveguide 40 to a substantially unlimited, uniform, axially symmetric distribution pattern, there is little need for rotation or movement of waveguide 40—even with rotation of secondary optic 42.

Body 60 of optical waveguide 40 preferably includes inner surface 96 and retaining flange 98. As can be seen from FIGS. 2-11, waveguide 40 is preferably a tapered circular shaft which channels light collected by collection optic 64 upward through waveguide 40, and into distribution optic 100. The waveguide is preferably constructed from a material which is totally internally reflective, such as acrylic, glass, polycarbonate and/or polystyrene. Acrylic may be preferred for cost and material property purposes. Of course, those of ordinary skill in the art with the present disclosure before them will recognize that the optical waveguide may likewise be constructed from other materials, particularly those which exhibit high optical clarity and/or those which promote total internal reflection.

In particular, the light rays entering waveguide 40 travel either directly from collection optic 64 to distribution optic 100, or by reflection off of inner surface 96 of body 60 one or more times to distribution optic 100. Inasmuch as the waveguide is most efficient when the substantial majority of the collected light is emitted through the distribution optic 100 of second end 62, it is preferred that the number of light rays which escape waveguide 40 through the walls of body 60 portion is minimized or completely eliminated. The presently contemplated materials generally have a critical angle to normal of approximately 42°-43°, thus promoting total internal reflection rather than the escape of light rays.

The tapered configuration of waveguide 40 helps minimize the size of the virtual focal region 120 of waveguide 40. In particular, the cylindrical tapered shape of the waveguide forces the light beams channeled through collection optic 64 to converge and travel through the narrower, smaller-diameter second end 62, where they eventually encounter distribution optic 100. This convergence creates a smaller virtual focal region. However, it is likewise contemplated that waveguide 40 may have a purely cylindrical shape or other variations thereon, as would be known by those with ordinary skill in the art with the present disclosure before them. Indeed, certain applications may call for a larger virtual focal region which is typically produced by a less tapered or purely cylindrical waveguide.

Retaining flange 98, shown in FIGS. 3-6, extends around the entirety of the outside surface of waveguide 40. As is shown in FIGS. 3 and 4, retaining flange 98 fits into a retaining structure in outer secondary optic 42. Inasmuch as waveguide 40 is relatively long and cylindrical, it is preferential to have waveguide 40 secured to the light source housing at bottom first end 58 by connection structure 66, and stabilized by secondary optic 42 at retaining flange 98. Moreover, inasmuch as retaining flange 98 preferably extends around the entirety of the circumference of waveguide 40, secondary optic 42 may be rotated or pivoted around waveguide 40 while maintaining the secured relationship of waveguide 40 with base 30.

Second end 62 of waveguide 40 includes distribution optic 100. As shown in FIGS. 3-7 and 10, distribution optic 100 includes first optical surface 101 and second optical surface 102. First optical surface 101 is preferably a reflective surface, with a generally concave shape. First optical surface 101 reflects the light rays channeled up through waveguide 40 toward second optical surface 102. In one embodiment, first optical surface 101 may be at least partially coated with a reflective coating. The reflective coating is preferably an aluminum-based material; however, other reflective coatings are likewise contemplated, including silver, silicon dioxide, iron dioxide, chromium, or other highly reflective materials or compounds, or a dielectric mirror coating, or a combination thereof.

Alternatively, first optical surface 101 may be a totally internally reflective surface, without a separate reflective coating. To this end, the first optical surface may be formed from a material which exhibits total internal reflection, such as those described above as used to construct the waveguide. Typically, first optical surface 101 will be totally internally reflective as a result of formation of the waveguide from a totally internally reflective material. Of course, first optical surface 101 may be formed from a totally internally reflective material, while also including a coating. Those with ordinary skill in the art with the present disclosure before them will appreciate that the shape of both the first optical surface and the second optical surface may be varied to optimize the light distribution pattern for a particular application, depending on the waveguide material selected and whether a separate reflective coating is used on the first optical surface.

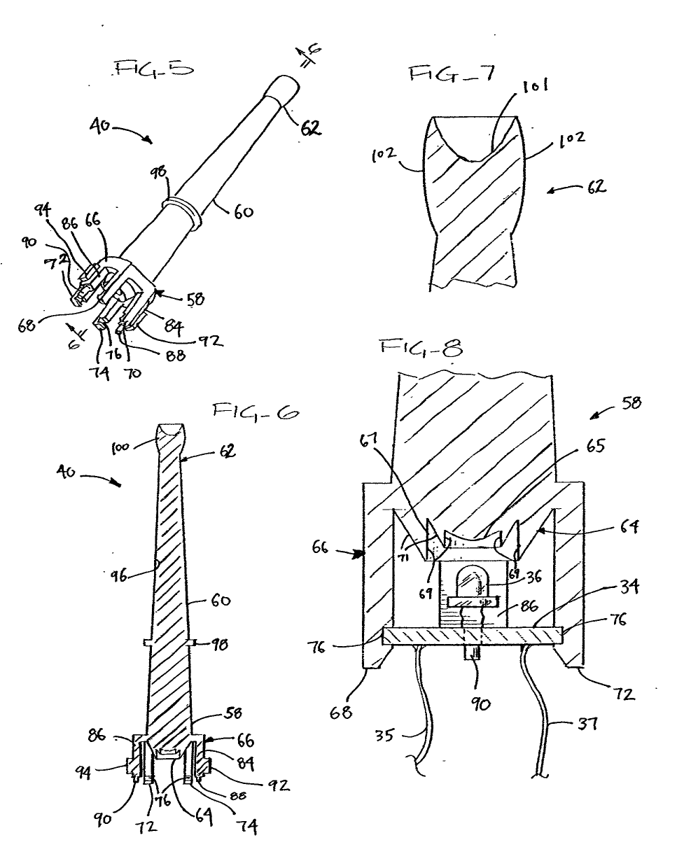

As can be seen from FIGS. 7 and 10, second optical surface 102 is preferably a convex, refractive surface which distributes light into a substantially uniform, axially symmetric distribution pattern. In particular, light is distributed around the entire 360° circumference of second optical surface, and preferably spans an angle approaching 180° in the vertical plane. Thus, light distribution is not only rotationally symmetric, but is broad enough to uniformly reach both the top and bottom of the outer secondary optic. The substantially axially symmetric output of the distribution optic 100 allows the outer secondary optic 42 to be rotated about the stationery waveguide source.

Moreover, the combination of first 101 and second 102 optical surfaces creates a virtual focal region 120 which appears just behind the reflective surface of distribution optic 100, and which is preferably pseudo-toroidal in shape and minimized in size. A smaller virtual focal region allows more control and efficiency in distribution of the light emitted from distribution optic 100 of optical waveguide 40 to secondary optic 42. A smaller virtual focus allows better control of the angular distribution generated by the external optic lens. Indeed, a smaller virtual focal region/point is similar to that of an incandescent filament.

Notably, while the shape of first optical surface 101 is shown as having an approximately parabolic shape, the shape and surface are preferably tailored to the type of light source 36, the output field of the light source 36, the collection optic 64, as well as the dimensions and material of waveguide 40. Indeed, the first optical surface may be non-uniform, as is contemplated and shown in FIGS. 7 and 10. Likewise, second optical surface 102, while appearing rather uniform in the shape of an inverted hyperbola, may likewise be a substantially non-uniform surface. Notably, the desired luminance of secondary optic 42 is likewise taken into account in the defining the exact shape, dimensions and contours of distribution optic 100.

Further, as would be known by those with ordinary skill in the art with the present disclosure before them, first optical surface 101 and second optical surface 102 may be modified to accommodate other desired light distribution patterns. For instance, in a siren, light is preferably emitted from the sides of the outer lens (secondary optic), rather than from the top of the cylindrically-shaped outer lens—as cars and pedestrians generally see light emitted from the side, not the top. Accordingly, a distribution optic employing a second optical surface having more of a pure cylindrical configuration, such as that shown in FIG. 12, may be desired to accomplish this purpose more efficiently. Indeed, a more cylindrical second optical surface would minimize light output from the top of the distribution optic, and focus more light in a rotationally symmetric distribution pattern emitted from the sides of the distribution optic. Likewise, the second optical surface may even take a concave or hyperbolic configuration, particularly if light is desired to be focused to specific points in a rotationally symmetric pattern. Indeed, one in ordinary skill in the art will readily recognize that modifying the second optical surface will modify the light distribution pattern from waveguide 40.

Secondary optic 42 is shown in FIGS. 2-4 as comprising a standard fresnel lens. Secondary optic 42 includes first lens 104 and second lens 106, which lenses are connected along their outer perimeter to enclose waveguide 40. Additionally, both first lens 104 and second lens 106 include retaining structures 108 and 110, respectively, on their inner surfaces to retain waveguide flange 98. As is conventional, secondary optic 42 may be rotated relative to base 30, to allow the outer lens to face oncoming traffic, pedestrians or any other desired direction, without moving the entire warning barricade.

While waveguide 40 has been described as used in combination with a lighting unit for a warning barricade device, it is likewise contemplated that optical waveguide 40 may be used in combination with any number of systems, including those which require the conversion of the light distribution pattern of a limited output light source to a substantially unlimited light distribution pattern. Indeed, the optical waveguide that is the subject of the present invention may be used in any number of other applications. For instance, the waveguide may be used in combination with a police or ambulance siren which can be mounted on top of an emergency vehicle, a walkway light which emits light from a secondary outer lens in a generally rotationally symmetric pattern, or a stern or marine light on boats which employ powerful LEDs for nighttime vision. Each of these applications would be benefited by a substantially uniform and axially symmetric light distribution pattern—converted from a limited light output source. Indeed, virtually any application which requires a secondary optic or outer lens would be benefited by the present optical waveguide invention.

The foregoing description and drawings merely explain and illustrate the invention, and the invention is not limited thereto except insofar as the appended claims as so limited as those skilled in the art having the present disclosure before them will be able to make modifications and variations therein without departing from the scope of the invention.

What is claimed is:

1. An optical waveguide for use in converting the distribution pattern of light from an LED source, the optical waveguide comprising:
a guide having at least two ends;
a collection optic positioned at one end of the guide for channeling light from said LED source into said guide;
a distribution optic positioned at a second end of the guide for receiving the light channeled through the guide by the collection optic,
said distribution optic including at least a first optical surface and a second optical surface, wherein at least a portion of said first optical surface is reflective so as to reflect at least a portion of the light channeled through the guide to the second optical surface, which emits a distribution pattern distinct from the distribution pattern of the LED source.

2. The optical waveguide according to claim 1 wherein the second optical surface distributes light channeled through the guide by refraction.

3. The optical waveguide according to claim 1 wherein the collection optic collimates light from said LED source into said guide.

4. The optical waveguide according to claim 1 wherein the distribution pattern from said distribution optic is substantially rotationally symmetric.

5. The optical waveguide according to claim 1 wherein the guide includes an inside surface, and wherein the inside surface of the guide is internally reflective to facilitate focusing of substantially all of the channeled light to the distribution optic.

6. The optical waveguide according to claim 1 wherein the guide is at least partially tapered from a larger diameter at said first end of said guide to a smaller diameter at said second end of said guide to focus the light channeled from the collection optic to the distribution optic.

7. The optical waveguide according to claim 1 wherein the optical waveguide is constructed from at least one of the light transmission materials selected from the group consisting of acrylic, glass, polycarbonate and polystyrene.

8. The optical waveguide according to claim 1 wherein the light output from the distribution optic defines a virtual focal region, said virtual focal region having a substantially axially symmetric configuration.

9. The optical waveguide according to claim 8 wherein the guide is at least partially tapered from a larger diameter at said first end of said guide to a smaller diameter at said second end of said guide to reduce the size of the virtual focal region, thus broadening the light distribution pattern emitted from the distribution optic.

10. The optical waveguide according to claim 9 wherein the first and second optical surfaces define a substantially torroidal virtual focal region.

11. The optical waveguide according to claim 1 wherein the collection optic includes at least one refractive segment and one reflective segment to enhance collection of light from said LED source.

12. The optical waveguide according to claim 11 wherein at least a portion of the at least one reflective segment of the collection optic is totally internally reflective to facilitate collection and channeling of wide angle LED light from said LED source.

13. The optical waveguide according to claim 1 wherein said first optical surface is substantially concave.

14. The optical waveguide according to claim 1 wherein said second optical surface is substantially convex.

15. The optical waveguide according to claim 1 wherein the first optical surface is formed from a totally internally reflective material.

16. The optical waveguide according to claim 1 wherein the first optical surface includes a reflective coating covering at least a portion thereof to reflect at least a portion of the light channeled through the guide to the second optical surface.

17. The optical waveguide according to claim 16 wherein the reflective coating covering at least a portion of the first optical surface is selected from the group of coatings consisting of aluminum, silver, silicon dioxide, iron dioxide, chromium and a dielectric mirror coating.

18. An optical waveguide for use in converting the distribution pattern of light from an LED source, the optical waveguide comprising:
a guide having at least two ends;
a collection optic positioned at one end of the guide for channeling light from said LED source into said guide;
a distribution optic positioned at a second end of the guide for receiving the light channeled through the guide by the collection optic,
said distribution optic including at least a first optical surface and a second optical surface, wherein at least a portion of said first optical surface is reflective so as to reflect at least a portion of the light channeled through the guide to the second optical surface, which distributes the light in a rotationally symmetric distribution pattern.

19. A method for transforming the distribution pattern of light from an LED source, said method comprising the steps of:
collecting light from the LED source through a collection optic into a guide;
channeling the light through the guide to a distribution optic, said distribution optic including at least a first optical surface and a second optical surface, wherein at least a portion of said first optical surface is reflective;
reflecting at least a portion of the channeled light off of the first optical surface toward the second optical surface;
emitting a light distribution pattern from said second optical surface of the distribution optic which is distinct from the distribution pattern of the LED source.

20. The method according to claim 19 wherein the step of emitting a light distribution pattern from said second optical surface includes transforming the light from the LED source initially collected by the collection optic into a substantially rotationally symmetric distribution pattern.

21. The method according to claim 19 wherein the step of emitting a light distribution pattern from said second optical surface of said distribution optic is accomplished at least partially by refraction.

22. The method according to claim 19 wherein the step of collecting light from the LED source through a collection optic further includes collimating light through the collection optic which includes refractive and reflective segments.

23. An optical system for transforming the light distributed from a limited output source, said optical system comprising:
a light source;
a primary optic coupled to the light source, said primary optic including
a collection optic positioned proximate to the light source for channeling light from said light source;
a distribution optic oriented to receive the channeled light from said collection optic, said distribution optic outputting the channeled light into a distribution pattern distinct from that emitted from the light source;
a secondary optic coupled to the primary optic, said secondary optic including at least one optical surface for transmitting the light emitted from the primary optic through the secondary optic to a surrounding environment.

24. The optical system according to claim 23 wherein said primary optic further includes a guide coupling the collection optic and the distribution optic.

25. The optical system according to claim 23 wherein said distribution optic of said primary optic emits a distribution pattern which is substantially rotationally symmetric.

26. The optical system according to claim 23 wherein said secondary optic includes a fresnel lens.

27. A warning light for use in combination with a warning barricade device, said warning light comprising:
a light source coupled to a power source;
a primary optic positioned proximate to the light source, said primary optic including
a collection optic for channeling light from said light source;
a distribution optic oriented to receive the channeled light from said collection optic, said distribution optic including at least a first optical surface and a second optical surface, wherein at least a portion of said first optical surface is reflective SO as to reflect at least a portion of the light channeled through the guide to the second optical surface, which emits a distribution pattern distinct from the distribution pattern of the LED source; and
a secondary optic coupled to the primary optic, said secondary optic including at least one optical surface for transmitting the light emitted from the primary optic through the secondary optic to the surrounding environment to render the warning light visible for use.

28. The warning light according to claim 27 wherein the primary optic further includes a guide coupling the collection optic to the distribution optic.

29. The warning light according to claim 28 wherein the guide is at least partially tapered from a larger diameter at said first end of said guide to a smaller diameter at said second end of said guide to focus the light channeled from the collection optic to the distribution optic.

30. The warning light according to claim 27 wherein light distribution pattern emitted by the distribution optic is broader than the light pattern emitted from light source, and substantially rotationally symmetric.

31. The warning light according to claim 27 wherein the primary optic further includes a connection structure to facilitate securement of the primary optic relative to the light source of the lighting unit.

32. The warning light according to claim 31 wherein said connection structure allows for releasable attachment of said primary optic relative to said lighting unit.

33. A warning barricade apparatus for restricting vehicular and pedestrian access to a particular area, said warning barricade apparatus comprising:
a barricade member;
a warning light associated with said barricade member;
said warning light including a light source coupled to a power source;
a primary optic positioned proximate to the light source, said primary optic including
a collection optic for channeling light from said light source;
a distribution optic oriented to receive the channeled light from said collection optic, said distribution optic including at least a first optical surface and a second optical surface, wherein at least a portion of said first optical surface is reflective so as to reflect at least a portion of the light channeled through the guide to the second optical surface, which emits a distribution pattern distinct from the distribution pattern of the LED source; and
a secondary optic coupled to the primary optic, said secondary optic including at least one optical surface for transmitting the light emitted from the primary optic through the secondary optic to the surrounding environment to render the warning light visible for use.
